(19) United States
(12) Patent Application Publication
(10) Pub. No.: US 2012/0085181 A1
(43) Pub. Date: Apr. 12, 2012

(54) TEMPERATURE ADJUSTMENT DEVICE FOR THERMAL SOLIDIFICATION OF ACTIVE INGREDIENT BEADS

(75) Inventors: Carsten ETZOLD, Bonaduz (CH); Frieder Neuhäusser-Wespy, Zurich (CH); Mareen Schmökel, Pagig (CH); Claudio Schmid, Sedrun (CH); Johann Seeber, Chur (CH)

(73) Assignees: Hamilton Company, Reno, NE (US); Hamilton Bonaduz AG, Bonaduz (CH)

(21) Appl. No.: 13/231,187

(22) Filed: Sep. 13, 2011

(30) Foreign Application Priority Data
Sep. 14, 2010 (DE) 10 2010 040 685.6

(51) Int. Cl. G01N 1/10

(52) U.S. Cl. 73/863.11

(57) ABSTRACT

The present invention relates to a temperature adjustment device (10) for adjusting the temperature of at least one sample container (12), which temperature adjustment device (10) comprises, for optional heat-transferring coupling of the sample container (12) therewith and for isolation of the sample container (12) therefrom, at least one sample container holder (16) extending along a holder axis (A), the temperature adjustment device (10) comprising a first temperature adjustment zone (26) and a second temperature adjustment zone (31) which can be operated separately therefrom, the first and second temperature adjustment zones (26, 31) being arranged in different axial regions of the sample container holder (16) relative to the holder axis (A).

The present invention relates to a temperature adjustment device for adjusting the temperature of at least one sample container, which temperature adjustment device comprises, for optional heat-transferring coupling of the sample container therewith and for isolation of the sample container therefrom, at least one sample container holder extending along a holder axis.

Such temperature adjustment devices are widely known items of laboratory equipment. They serve in general to adjust the temperature of a sample accommodated in the sample container to a specified temperature.

Instances are however also conceivable in which it is desirable to adjust the temperature of the sample container differently in different regions, for instance because the material accommodated in the sample container is to be brought only locally to a desired temperature while in other regions a different temperature is desired, or because a liquid is accommodated in the sample container, into which a different material of greater density than that of the liquid accommodated therein is to be introduced and this material needs to pass through different temperature zones as it becomes immersed in and sinks through the temperature-adjusted liquid.

The object of the present invention is accordingly to provide technical teaching with which it is possible to adjust the temperature of a sample container differently in different regions.

This object is achieved by a temperature adjustment device of the above type which comprises a first temperature adjustment zone and a second temperature adjustment zone which can be operated separately from the first, the first and second temperature adjustment zones being arranged in different axial regions of the sample container holder relative to the holder axis.

Thus, at least two temperature adjustment zones may be provided along the holder axis of the sample container holder, which may be operated separately and may thus be set to different temperatures.

Mention of a first and a second temperature adjustment zone is not intended to exclude the possibility of providing further temperature adjustment zones in addition to these two temperature adjustment zones, which further zones are in turn provided in axial regions of the sample container holder different from those of the other temperature adjustment zones and which may furthermore be set to a specified temperature independently of the respective other temperature adjustment zones.

As a result of the ability of the first and the second temperature adjustment zones and optionally further temperature adjustment zones to be independently set, these may be set to different temperatures.

It is thus for example possible to ensure that a liquid accommodated in the sample container, whose temperature is adjusted by the temperature adjustment device present and which displays a temperature dependent viscosity, displays different viscosities in the different temperature adjustment zones.

For further discussion of the temperature adjustment zones it should be assumed that the sample container holder of the temperature adjustment device extends when used properly with a profile component extending in the direction of gravity and the first temperature adjustment zone is positioned above the second temperature adjustment zone relative to the direction of gravity. This is above all advantageous if the first temperature adjustment zone is designed to heat a sample container accommodated in the sample holder to a higher temperature than the second temperature adjustment zone, since then in the case of liquids heated in the sample container stable stratification is conventionally obtained. The reason for this is that the density of liquids usually falls as the liquid temperature rises.

Although the first temperature adjustment zone may in principle set any desired temperature in a sample container accommodated in the sample container holder, it is nevertheless preferable for the first temperature adjustment zone to be designed to heat a sample container accommodated in the sample container holder to a temperature which is equal to or higher than the ambient temperature of the temperature adjustment device. The first temperature adjustment zone is preferably designed to heat a sample container accommodated in the sample container holder to a temperature of 20° C. to 30° C., preferably to a temperature of 20° C. to 25° C., particularly preferably to a temperature of 22° C. to 25° C.

In addition or alternatively, the second temperature adjustment zone may be designed to cool a sample container accommodated in the sample container holder to a temperature which is lower than the ambient temperature of the temperature adjustment device. The second temperature adjustment zone is preferably designed to heat a sample container accommodated in the sample container holder to a temperature of 0° C. to 15° C., particularly preferably to a temperature of 2.5° C. to 12.5° C.

To make handling of the sample containers and the temperature adjustment device as simple as possible when filling the latter with sample containers it is advantageous for the sample container holder to comprise a holder opening through which the sample container may be introduced into the sample container holder and through which the sample container may be removed from the sample container holder.

When the sample container is introduced through the holder opening into the sample container holder in the direction of gravity, it is advantageous, to achieve stable liquid zones adjusted to different temperatures in the sample container, for the first temperature adjustment zone to be arranged closer to the holder opening than the second temperature adjustment zone.

In principle, the first temperature adjustment zone may release heat to the sample container holder through any desired physical interaction. To achieve maximally simple but accurate temperature control, it is however preferable for a preferably electrical heating element to be provided in the first temperature adjustment zone. To transfer heat from the heating element to the sample container holder, a heat transfer medium may be provided. In this case, a rigid heat transfer medium is preferred, such as for instance metal, whose electrical conductivity correlates over extensive ranges with its thermal conductivity, such that a metal of low specific electrical resistance is preferred as the heat transfer medium in the first temperature adjustment zone.

Furthermore, the use of rigid, i.e. not liquid or viscous heat transfer media lends the temperature adjustment device a desired degree of robustness.

In terms of the second temperature adjustment zone, on the other hand, this may advantageously be flowed through by a second heat transfer medium. Flowable, i.e. viscous heat transfer media, make it in particular possible for the low temperatures desired for the second temperature adjustment zone to be more readily achieved than with corresponding electrical elements. Suitable viscous heat transfer media additionally make it possible to achieve temperatures below the freezing point of water in the second temperature adjustment zone of the sample container holder. In order reliably to ensure that temperatures may be set as independently as possible in the different temperature adjustment zones, provision may be made for an insulation zone to be provided between the first and second temperature adjustment zones to insulate said first and second zones thermally from one another.

It is furthermore advantageous for a temperature adjustment device not to comprise just a single sample container holder and thus be able to adjust the temperature of substantially just one sample container at once, although this is not intended to be ruled out by the present invention. It is however more advantageous and economic for the temperature adjustment device to comprise a plurality of sample container holders. In this case it is additionally advantageous with regard to handling of the sample containers and the temperature adjustment device for the plurality of sample container holders to have substantially parallel holder axes, such that introduction of sample containers into and removal of sample containers from the sample container holders is substantially identical over all the sample container holders.

In the preferred case in particular, in which with the temperature adjustment device stable stratification of a liquid, in particular oil, is to be achieved in a sample container by means of differently temperature-adjusted temperature adjustment zones along the holder axis, it is advantageous for the holder axis of the at least one sample container holder to be oriented in the direction of gravity.

Such stratification of a temperature-adjusted liquid, in particular of a temperature-adjusted oil, may be of considerable advantage when producing active ingredient beads.

Active ingredient beads used as depot drugs have become medically very important due to the treatment successes achieved with them.

Active ingredient beads generally comprise an excipient, in which there may be embedded an active ingredient or a material which produces an active ingredient over a finite effective period as a result of chemical and/or biological reaction.

Since the active ingredient of the active ingredient bead generally achieves an effect after uptake in the human or animal body, in the present application the active ingredient and the material producing the active ingredient are denoted by the generic term “biologically active material”.

Gel-type materials have proven to be suitable excipients, biopolymers, such as in particular agarose, being at the forefront due to their good tolerability in the human or animal body.

In principle, excipients are initially present, for embedding of the biologically active material therein, as a shapeless, flowable, but solidifiable mass, into which the biologically active material may be mixed.

As it solidifies, the active ingredient bead assumes a generally spherical shape, the dimensional stability of the active ingredient bead not being particularly great however, depending on the progress of solidification, and not being comparable with a rigid solid.

The low dimensional stability during the production phase furthermore makes the active ingredient bead particularly sensitive to the action of external force, which has hitherto made it very difficult to automate production of active ingredient beads. In fact, for numerous applications active ingredient beads are produced virtually completely by hand.

Such biopolymers, in particular agarose, are thermally solidifiable, such that particularly advantageously biopolymer to be solidified is introduced gently into the first, warmer temperature adjustment zone of a liquid temperature-adjusted by the above-described temperature adjustment device, sinks in the direction of gravity, and in so doing arrives in the colder second temperature adjustment zone of the same liquid, the rate of sinking slowing down due to the higher viscosity arising at lower liquid temperatures and heat release from the biopolymer to the liquid increasing in the second temperature adjustment zone precisely as a result of the lower liquid temperature and thus of the initially greater temperature difference between biopolymer and liquid in the second temperature adjustment zone.

Thus, the now more slowly sinking bead blank is available for heat release and thus solidification for a longer period over the same sinking distance, such that it is sufficiently solidified before it reaches the bottom of the sample container, on which it lies under mechanical load due to its intrinsic weight.

For this reason, independent protection is claimed for use of a temperature adjustment device for solidifying active ingredient beads having an excipient, preferably a gel-type excipient, particularly preferably a biopolymer, such as for instance agarose, and having a biologically active material embedded in the excipient, such as for instance an active ingredient and/or a material producing active ingredient, in a sample container filled with fluid, accommodated in the sample container holder and temperature-adjusted by the temperature adjustment device.

For this use provision may be made for the starting material of the active ingredient bead to be present, before it is introduced into the fluid in the sample container, as a substantially shapeless, flowable and solidifiable mixture, comprising the excipient and the biologically active material. “Starting material” here denotes a material which includes at least the excipient and the biologically active material.

Furthermore, with a different type of active ingredient beads the above-described, temperature-adjusted fluid may also advantageously assist with solidification, namely in the case of those active ingredient beads which comprise as bead blank a solidified core and an unsolidified or incompletely solidified shell around the solidified core. In this case the introduction of such an active ingredient bead blank may assist in gentle solidification of the shell.

The present invention is explained in more detail below with the aid of the attached drawing, in which:

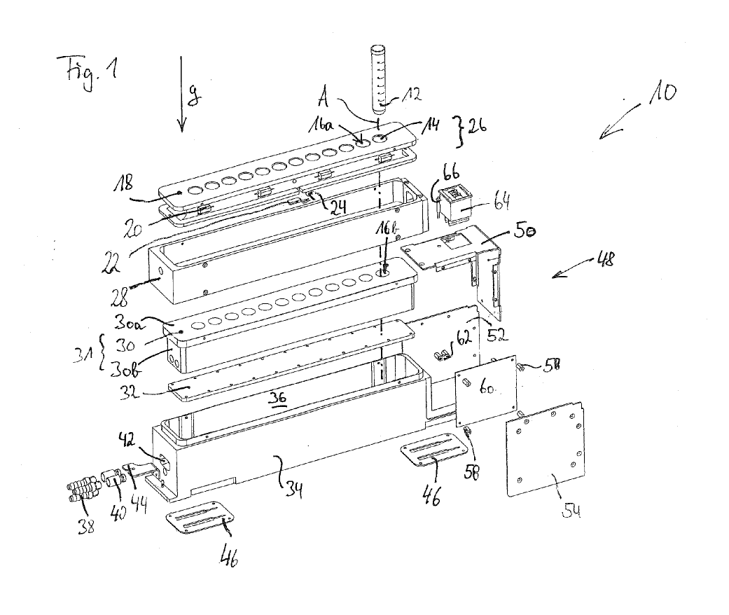

FIG. 1 is an exploded representation of an embodiment according to the invention of a temperature adjustment device of the present application.

In FIG. 1 an exploded view of an embodiment according to the invention of a temperature adjustment device is denoted in general as 10.

The temperature adjustment device 10 serves to adjust the temperatures of sample containers 12, which may be introduced into a sample container holder 16 inside the temperature adjustment device 10 and removed therefrom through a holder opening 14 along a holder axis A.

To this end, the heating device 10 comprises a heating block 18 preferably of metal placed relatively close to the holder opening 14, which block is equipped with a plurality of heating resistors 20, eight in the example shown. The heating resistors 20 are controlled by a thermostatic switch 22 on the basis of signals from a temperature sensor 24.

The heating block 18 forms a first temperature adjustment zone 26 over its axial extent along the holder axis A.

The heating block 18 is accommodated in an intermediate insulator 28, which surrounds the heating block 18 when assembled. The heating block 18 is followed axially and spacedly by a cooling block 30, which likewise contributes to formation of the sample container holder 16.

More precisely, a first, in FIG. 1 upper, axial portion 16a of the sample container holder 16 is formed in the heating block 18, a lower portion 16b of the sample container holder 16 being formed in the cooling block 30.

The cooling block 30 is closed at the bottom by a base 32, which is screwed or otherwise fastened onto the cooling block 30.

The cooling block, whose lid portion 30a is surrounded by a lower region, in FIG. 1, of the intermediate insulator 28 when the temperature adjustment device 10 is in the assembled state, projects into an insulator 34 with its body region 30b onto which the base 32 is screwed.

The insulator 34 comprises a cavity 36, which is larger than the body portion 30b of the cooling block 30 projecting thereinto, such that cooling liquid may flow through the cooling block 30 in the insulator 34, or more precisely in the remaining flow space in the cavity 36, which cooling liquid may be introduced into the cavity 36 of the insulator 34 by hose nipples 38 and intermediate pieces 40 via an opening 42.

The temperature adjustment device 10 may advantageously be fixed in a support by means of a fixing lug 44.

Alternatively or in addition, the temperature adjustment device 10 may be fastened to a support via the slot/slide mounts 46.

At the opposite longitudinal end from the coolant inlet and outlet, a control housing 48 is provided on the temperature adjustment device, which housing is formed from an angled housing part 50 and two side panels 52 and 54.

On one of the side panels (here side panel 54) a circuit board 60 is arranged via spacers 58, on which board the control electronics are arranged for controlling the temperature of the temperature zones. In the case shown, power may be supplied to the circuit board 60 via “cable clamps” 62, which are preferably fixed to the side panel 52, which is arranged opposite the side panel 54 accommodating the circuit board 60.

The control circuit of the circuit board 60 is preferably connected to a binary coded decimal switch or BCD switch 64 for setting the temperatures in the individual temperature zones.

The cooling block 30 defines a second axial temperature adjustment zone 31.

The temperature adjustment zones 26 and 31 are provided at an axial distance from one another, therefore not immediately adjoining one another and also not overlapping one another.

A light emitting diode 66 or another signal means may be provided, in order to indicate correct functioning of the controller and/or the temperature adjustment device 10.

The temperature adjustment device 10 illustrated in FIG. 1 comprises twelve sample container arrangements 16 arranged substantially in parallel.

It goes without saying that the temperature adjustment device may also comprise just one sample container holder or any desired number of sample container holders 16.

The temperature adjustment device 10 is preferably designed such that a temperature may be set in the first temperature adjustment zone 26, which temperature includes room temperature and/or is higher than the room or ambient temperature of the temperature adjustment device 10.

For the particularly preferred case of temperature adjustment of oil in the sample containers 12 for solidification of the active ingredient beads stated above in the introduction to the description, comprising biopolymer, preferably agarose, the first temperature adjustment region 26 is preferably set to temperatures of 20° C. to 30° C., particularly preferably to a temperature of 20° C. to 25° C. and particularly preferably to a temperature of 22° C. to 25° C. At this temperature the excipient initially present as a flowable mass may be introduced gently, i.e. without thermal shock, into the oil in the sample container.

The second temperature adjustment zone 31, which in the direction of gravity g lies preferably axially below the first temperature adjustment zone, may be set with a suitable cooling liquid to temperatures of below the freezing point of water, in any case of below the room or ambient temperature of the temperature adjustment device 10.

This has the advantage for the particularly preferred use of the present temperature adjustment device 10 for producing active ingredient beads that the oil in the sample container 12, whose viscosity is conventionally temperature-dependent, is more viscous in the second, cooler temperature adjustment zone 31, such that a bead blank, which sinks in the sample container 12 in the direction of gravity g, is slowed down with regard to its sinking rate and at the same time proceeds into an increasingly cooler oil zone, such that sufficient heat may be removed from it, so that the bead blank reaches the bottom of the sample container 12 in a sufficiently solidified state and is not damaged by the application pressure arising there.

Unlike in the present embodiment, which is preferred due to its simple but reliable structure, the temperature adjustment device according to the invention may comprise more than two temperature adjustment zones, the temperatures of which may be mutually independently set.

Because in the example described here the first temperature adjustment zone has a higher temperature than the second temperature adjustment zone located therebelow in the direction of gravity g, a stable stratification is conventionally obtained, since in particular liquids and gases in the sample container conventionally exhibit a density which decreases as the temperature rises.

1. A temperature adjustment device (10) for adjusting the temperature of at least one sample container (12), which temperature adjustment device (10) comprises, for optional heat-transferring coupling of the sample container (12) therewith and for isolation of the sample container (12) therefrom, at least one sample container holder (16) extending along a holder axis (A), characterised in that the temperature adjustment device (10) comprises a first temperature adjustment zone (26) and a second temperature adjustment zone (31) which can be operated separately therefrom, the first and second temperature adjustment zones (26, 31) being arranged in different axial regions of the sample container holder (16) relative to the holder axis (A).

2. A temperature adjustment device according to claim 1, characterised in that the first temperature adjustment zone (26) is designed to heat a sample container (12) accommodated in the sample container holder (16) to a temperature which is equal to or higher than the ambient temperature of the temperature adjustment device.

3. A temperature adjustment device according to claim 1, characterised in that the second temperature adjustment zone (31) is designed to cool a sample container (12) accommodated in the sample container holder (16) to a temperature which is lower than the ambient temperature of the temperature adjustment device.

4. A temperature adjustment device according to claim 1, characterised in that the sample container holder (16) comprises a holder opening (14) through which the sample container (12) may be introduced into the sample container holder (16) and through which the sample container (12) may be removed from the sample container holder (16), the first temperature adjustment zone (26) being closer to the holder opening (14) than the second temperature adjustment zone (31).

5. A temperature adjustment device according to claim 1, characterised in that in the first temperature adjustment zone (26) a preferably electrical heating element (20) is provided, which transfers heat to the sample container holder (16a) via a preferably rigid first heat transfer medium.

6. A temperature adjustment device according to claim 1, characterised in that the second temperature adjustment zone (31) may be flowed through by a second heat transfer medium.

7. A temperature adjustment device according to claim 5, characterised in that an insulation zone is provided between the first (26) and second temperature adjustment zones (31) to insulate the first (26) and second zones (31) thermally from one another.

8. A temperature adjustment device according to claim 1, characterised in that it comprises a plurality of sample container holders (16), which are preferably provided with substantially parallel holder axes (A).

9. A temperature adjustment device according to claim 1, characterised in that the holder axis (A) of the at least one sample container holder (16) is oriented in the direction of gravity (g).

10. Use of a temperature adjustment device (10) according to claim 1 to solidify active ingredient beads with an excipient, preferably a gel-type excipient, particularly preferably a biopolymer, such as for instance agarose, and with a biologically active material embedded in the excipient, such as for instance an active ingredient and/or a material producing active ingredient, in a sample container (12) filled with fluid, accommodated in the sample container holder (16) and temperature-adjusted by the temperature adjustment device (10).

11. Use according to claim 10, characterised in that before it is introduced into the fluid of the sample container the starting material of the active ingredient bead is present as a substantially shapeless, flowable and solidifiable mixture, comprising the excipient and the biologically active material.

12. Use according to claim 10, characterised in that before it is introduced into the fluid of the sample container the active ingredient bead comprises a solidified core and a flowable shell surrounding the solidified core, preferably comprising the excipient.
